(19) United States
(12) Patent Application Publication
(10) Pub. No.: US 2013/0304592 A1
(43) Pub. Date: Nov. 14, 2013

(54) DIGITAL MEDIA POINT OF SALE APPARATUS AND RELATED METHODS

(71) Applicant: Guillermo Brillembourg WILLSON, Caracas (VE)

(72) Inventor: Guillermo Brillembourg WILLSON, Caracas (VE)

(21) Appl. No.: 13/469,210

(22) Filed: May 11, 2012

(51) Int. Cl. G06Q 20/18; G06Q 20/20

(52) U.S. Cl. 705/17

(57) ABSTRACT

A system directed to a networked kiosk used to download digital content or media to a user's portable electronic or communication device. The kiosk includes a display, digital storage, means to connect to the internet, and payment acceptance means. The kiosk can presents digital media for selective purchases, recognizes and communicates with proximate portable electronic devices, and provides advertisements to users.

### FIELD OF THE INVENTION

The present invention relates to a digital media point of sale apparatus for the marketing and sales of digital media content and related methods.

### BACKGROUND OF THE INVENTION

Kiosks of various functions are commonly found in public venues, ranging from movie theaters for the purchase of tickets and passenger check-in kiosks in airports. The functions of typical kiosks are numerous, ranging from sales and communications to food distribution.

Currently, media such as newspapers, magazines, books, and movies are either purchased in hard-copy or instead electronically downloaded from a network. In the latter circumstance, an electronic device must connect to a network, typically the internet in order to purchase the media from an online seller of downloadable media.

Unfortunately, downloading media requires an internet connection, which is not always available. Some devices, such as smart phones have relatively persistent internet connectivity, but download speeds are slow, so downloads take a considerable amount of time. Videos, for example are often stored in relatively large digital files, so even with a fast Internet connection the time to download a file may be significant.

There is a need for a kiosk that can deliver digital media content to a consumer, and to do so quickly to obviate the need for an Internet connection. This would be particularly useful for individuals lacking the requisite time necessary to effectuate a large file download form the internet, such as, but not limited to, travelers at an airport who would like to download a movie, but do not have the time to wait due to tight flight schedules. A kiosk that has media files stored locally could allow the transfer to media in a far faster manner than through internet downloads. A kiosk of this nature could also provide an advertising outlet as well as communications means. Advertising can be displayed on external 2D or 3D video displays and through audible and olfactory cues.

Besides providing a means to communicate through the kiosk such as a telephone or VOIP interface, a kiosk also provides a means to allow customer's to communicate using their own wireless telephones. Additionally, the kiosk functions to providing a means for purchasing telephone SIM cards through a SIM dispensing means. This allows a traveler, for example, to arrive in a foreign country, purchase a SIM card having a new telephone number from the kiosk, and using this SIM card in their personal wireless phone.

Kiosks are also traditionally bulky boxes that take up a lot of space upon installation. This is especially true when a venue opts to install multiple bulky units. There is a need for a kiosk form factor that is relatively small, yet efficiently scalable.

No known kiosk system adequately provides local access to media files for immediate, short-duration downloading; provides outlets for visual, audible, and olfactory advertising; provides an outlet for telephone or VOIP communication; provides a means to receive a wireless telephone SIM; and provides this in a small, yet expandable, form factor so that a venue can display between one and twelve units, scaling up or down at will.

### SUMMARY OF THE INVENTION

It is an object of the present invention to provide a kiosk comprising at least one panel for the purpose of providing structure to the kiosk and to provide a point of user interaction by a user. A connecting means of the panel allows a multiple panels to connect with each other so like panels can be connected to each other for the purpose of assembling a multi-panel kiosk. A 2D or 3D display device is in association with the panel that displays a digital user interface and advertising to a user. At least one fragrance dispenser proximate the user interface for the purpose of dispensing olfactory cues to aid in advertising. Means to connect a portable electronic device to the panel in order to effectuate transfer of digital media files to portable electronic device are provided to the user of the kiosk. The kiosk also comprises distribution means on the panel for distributing a SIM card to a user. A credit card acceptance means on the panel for a user to provide payment information to the kiosk to pay for goods and services rendered by the kiosk is also contemplated by the invention.

In another embodiment of the invention the kiosk comprises at least one panel for the purpose of effectuating user interaction with the kiosk, each panel having a connecting means so that the panel can physically connect to like panels for the purpose of assembling a multi-panel kiosk. Connecting means of the panels exist so that the panels can electronically and electrically connect to other like panels for the purpose of assembling a multi-panel kiosk. A processing unit of the kiosk that runs software for operating the kiosk provides a user interface, point of sale and payment processing functionality, VOIP service functionality, and advertising functionality. Additionally a digital shopping cart is in communication with the user interface. This is all viewed by a display device in association with the panel that communicates with the processing unit and is controlled by the software. To augment advertising, at least one fragrance dispenser proximate the user interface that is controlled by the software for the purpose of dispensing olfactory cues releases fragrance that augments visual advertising efforts. A touch screen is in association with the panel that communicates with the processing unit and is controlled by the software and accepts user input. The kiosk also comprises means to connect a portable electronic device to the panel to effectuate transfer of digital media files to portable electronic device. Yet another function of the kiosk is to: a) Provide connectivity between the customer's electronic device/smartphone and the processing unit, the processing device serving as an input and output device for telephone calls and VOIP services, b) Provide a telephone handset in communication with the processing unit that serves as an input and output device for telephone calls and VOIP services. A video camera on the panel and in communication with the processing unit allows a user to be video recorded for the purpose of making a video call. A distribution means on the panel for distributing a SIM card to a user. A credit card acceptance means is on the panel for a user to provide payment information to the kiosk so that the user can pay for goods and services rendered by the kiosk.

The invention also contemplates a method of assembling a kiosk assembly comprising the steps of providing a plurality of kiosk panels, each panel being an individual functional kiosk unit having a top, bottom, and side edges, and a substantially flat profile, the side edges comprising at least one connecting means for the purpose of attaching the side edge of an individual panel to the side edge of another individual panel; connecting one side edge of an individual kiosk panel to the side edge of another individual kiosk panel to form a kiosk assembly; connecting a single processing unit to control all the kiosk panels of a kiosk assembly; and installing the kiosk assembly in a venue.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 illustrates a front perspective view of one embodiment of the kiosk;

FIG. 2 illustrates one a front view of the embodiment of the kiosk as shown in FIG. 1;

FIG. 3 illustrates a top view of a multi kiosk configuration having three kiosks;

FIG. 4 illustrates a top view of a multi kiosk configuration having four kiosks;

FIG. 5 illustrates a top view of a multi kiosk configuration having six kiosks; and

FIG. 6 illustrates a top view of a multi kiosk configuration having six kiosks.

### DETAILED DESCRIPTION OF THE PREFERRED EMBODIMENTS

In the Summary of the Invention above and in the Detailed Description of the Invention and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other ingredients, ingredients, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

In this section, the present invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

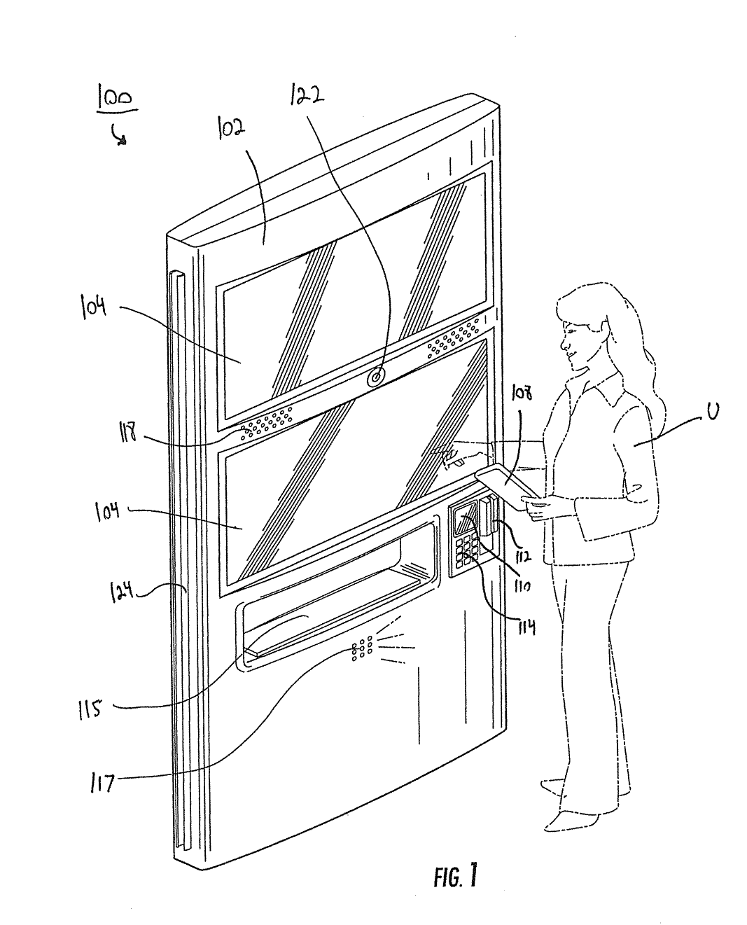

FIG. 1 illustrates a kiosk 100 for the promotion and sales of digital media. A front panel 102 provides a structure with which a user (U) interacts with the kiosk 100, and also a point to which various features of the kiosk are accessed or displayed. The panel is made from at least one of metal, plastic, wood, wood products, and any other material known in the art. At least one display device 104 is accessible to the user. The display device is an LCD, CRT, plasma, OLED, or any other type of display device known in the art. In one embodiment, the display 104 is a 3D display device. The display device prompts the user for interaction, displays items for sale, displays previews of digital media for sale, provides instructions on how to interact with the kiosk 100, and displays advertisements. In kiosks with multiple displays 104, advertisements are displayed, in 2D or 3D, on one display 104, while the user (U) interacts with the kiosk through a different display 104. Advertisements are of a set duration or may be continually looping. For example, in one embodiment a graphical user interface (GUI) 106 is displayed on the display device 104 that displays icons and menus on a home page that organizes the items for sale, such as newspapers, magazines, books, movies, videos, applications, and SIM chips for mobile phones. The GUI 106 provides a means to list prices for media and SIM chips and directs the user (U) to pay for such items. The GUI 106 comprises a digital shopping cart function to aid in the purchase of items.

With continuing reference to FIG. 1, the kiosk 100 comprises a point of sale interface and a credit card reader 112. To pay for purchase made through the kiosk 100, a user (U) can swipe a credit card through the credit card reader 112. In addition, the GUI 106 comprises a dialogue to prompt the user (U) to enter her credentials to access a personal user account. The information of the personal user account is stored in a database.

The personal user account comprises the user's personal data, wherein the user's personal data comprises at least one of a user's name, user's address, and a user's phone number. The personal user account also comprises the user's account data, wherein the user's account data comprises a username, a password, and media device 108 preferences. The personal user account also comprises the user's payment data, wherein the user's payment data comprises at least one of a billing address, credit card number, bank account number, and online payment processor credentials. It is not necessary for a user (U) to create a user account, in which case payment is tendered merely by swiping a credit card through the credit card reader 112.

Still referring to FIG. 1, media items for sale are available in a downloadable digital format. Multiple formats are available to maximize compatibility with the maximum number of digital media devices 108. Such media devices 108 include cellular phones, smartphones, computers, PDAs, tablet computing devices, digital music players, e-book readers, and any other devices known in the art. The user (U) connects the media device 108 to the kiosk 100 though a device interface 110. The device interface 110 is at least one of a cable, cradle, wifi connection, Bluetooth connection, USB connection, IEEE 1394 connection, and any other means to rapidly communicate between electronic devices known in the art. Additionally, the kiosk 100 identifies the operating system, communications protocol, and device information of the media device 108, employing methods known in the art.

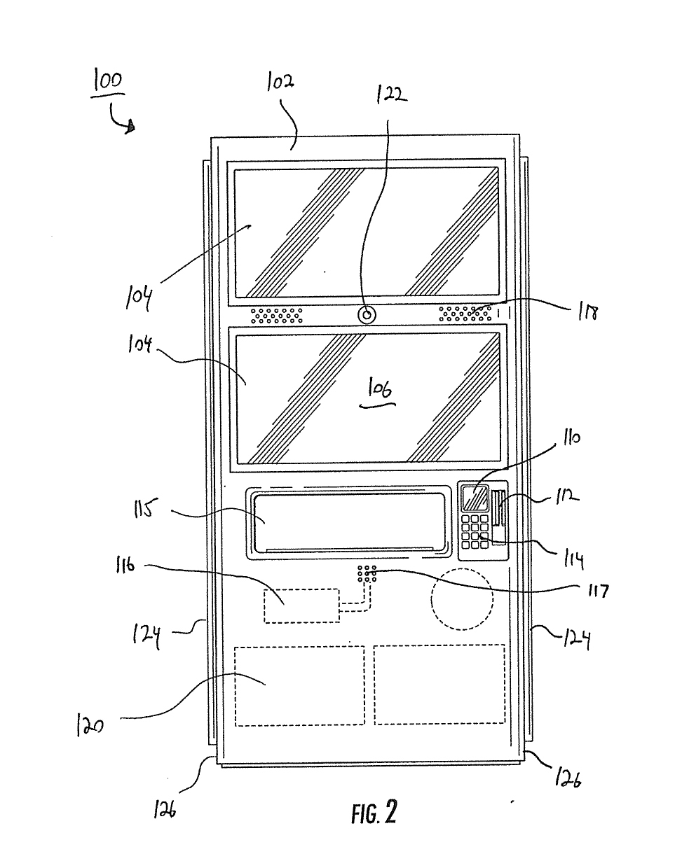

In one embodiment, as shown in FIGS. 1 and 2, the user (U) creates a personal user account, and the user (U) has the option of installing a software application on the media device 108, which provides additional functionality to interfacing with the kiosk 100. The media items downloaded from the kiosk 100 are displayed in an interface and are sortable, while adult content media may optionally be stored in an interface on the media device 108 to be generally “hidden” from casual view (and optionally password protected). Additionally, the media device 108 transmits device information, user information, and user preferences to the kiosk 100. Additionally, targeted advertising may be sent to the media device 108 from the kiosk 100 to be displayed within the application on the media device 108. Alternatively, advertisements may be sent to devices 108 detected that are in proximity to the kiosk 100, by wifi, Bluetooth, SMS, and any other communication protocol known in the art.

In one embodiment, at least one display device 104 is also an input device, preferably in the form of a touch-reactive screen (touchscreen). The touchscreen is at least one of the types being resistive, dispersive signal, surface acoustic wave, capacitive, infrared, optical, and acoustic. A touchscreen enables the user (U) to interact directly with what is displayed, rather than indirectly with a pointer controlled by an additional peripheral such as a mouse. Additionally, the touchscreen allows the user (U) to interact with the kiosk 100 without requiring any intermediate device that would otherwise need to be held in a user's (U) hand.

The kiosk 100 comprises a pocket 115 wherein a user (U) may place a media device 108 for the purpose of connecting to the kiosk 100, and for charging the device 108.

With reference to FIG. 2, the display device 104 displays, inter alia, advertisements. Coordinated with advertisements is the release of a fragrance from a fragrance dispenser 116. The fragrance dispenser 116 comprises an electronically controlled reservoir pump that sprays atomized liquid fragrance into the air proximate the kiosk 100 through a fragrance outlet 117. The fragrance dispensed serves as an olfactory cue to compliment the advertisements on the display device 104 and to pique consumer interest. The fragrance dispenser is controlled by software running on a processing unit 120 that coordinates dispensing fragrances with advertising efforts. Additionally, audible cues may also coincide with advertising, and these would emanate from speakers 118 on the front panel 102. Such cues may be sounds, dialogue, and music.

The processing unit 120 controls the kiosk 100, having means to process information (such as a CPU), storage means (such as hard drives), memory, peripheral input and output function, networking and communication means, and any other functionality known in the art.

The processing unit 120 communicates with a computer network of like kiosks 100. Therefore, a user that creates an account with a single kiosk has account access in any of the like kiosks 100 of the network. Kiosks 100 at multiple geographic locations create a wide web that offers not only a wide advertising platform but, but a network of kiosks 100 capable of recognizing a user anywhere that user interacts with other kiosk 100 units. The networked status of the kiosks 100 also provides a simple means to mass deliver advertising. For example, an advertisement can be uploaded to the network and, if desired by a network administrator, the advertisement would be uploaded for display on every kiosk 100 on the network.

With continuing reference to FIG. 1, a numerical keypad 114 provides an easy interface for a user (U) to make a telephone call using either traditional land-lines or through voice over IP such as Skype®. A virtual keypad may also be displayed on the display 104 being touch-reactive. The display 104 also provides a screen display for video calls. A video camera 122 is on the front panel 102 to record the user (U) for video calls. In one embodiment, the user (U) connects to the kiosk 100 using their own personal handset/smartphone, and makes VOIP or video call, using their persona handset/smartphone through a network attached to the kiosk 100, thus using the connection and the display 104 of the kiosk 100. The kiosk 100 automatically detects the presence of handsets/smartphones compatible with the VOIP feature of the kiosk 100.

### Method of Kiosk Assembly

With reference to FIGS. 1 and 2, the kiosk 100 comprises a connecting means 124 on the side edges 126 of the kiosk 100. The connecting means 124 are situated either in the middle or edge of the side edge 126. The connecting means 124 is used to attach a kiosk 100 to another like kiosk 100. The connection means 124 is a hinged joint that provides a secured, yet articulable connection.

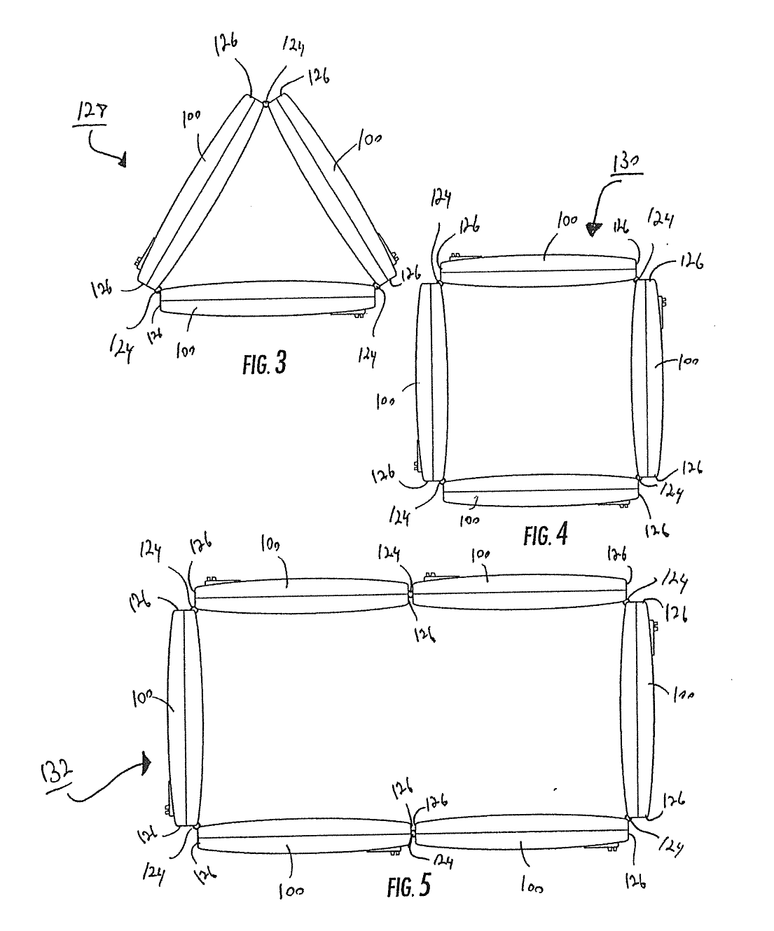

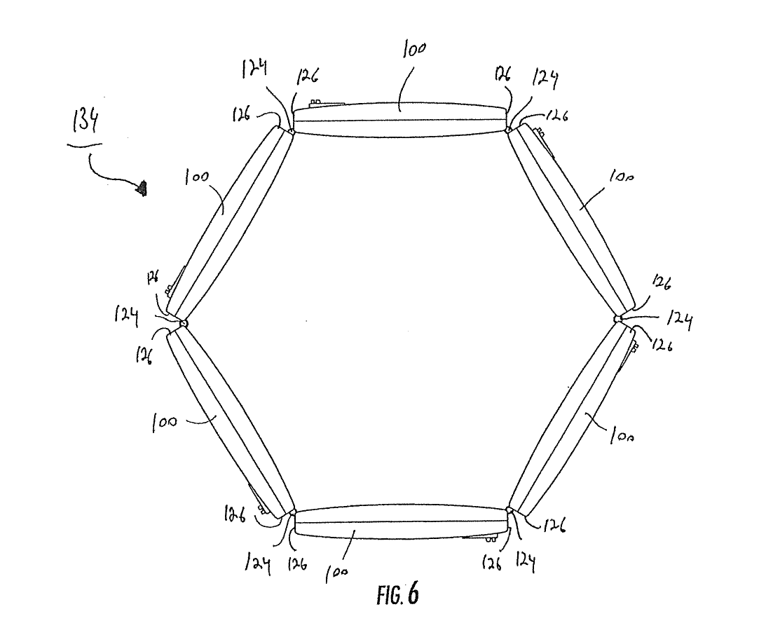

FIGS. 3-6 illustrate some examples of multi kiosk configurations wherein a kiosk 100 is attached to two other like kiosks 100 by the connecting means 124 of each kiosk. Each kiosk 100 has a substantially flat profile so that multiple configurations are possible. FIG. 3 illustrates a triangular arrangement 128 comprising 3 kiosks 100. FIG. 4 illustrates a square arrangement 130 comprising 4 kiosks 100. FIG. 5 illustrates a rectangular arrangement 132 comprising 6 kiosks 100. FIG. 5 illustrates a polygonal arrangement 134 comprising 6 kiosks 100.

In one embodiment of a multi kiosk configuration 128, 130, 132, 134 a single processing unit 120 controls all of the kiosks 100. Similarly, each kiosk 100 can connect to the electrical connection of the adjacent kiosk, so that only one electrical outlet provides power to each kiosk of a multi kiosk configuration 128, 130, 132, 134.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed:

1. A kiosk comprising:
a substantially vertical structural panel of the kiosk to provide a point of user interaction by a user with the kiosk;
connecting means fitted with the panel so that the panel can connect to like panels for the purpose of assembling a multi-panel kiosk;
a display device in association with the panel that displays a digital user interface and advertising to a user;
a fragrance dispenser proximate the user interface for the purpose of dispensing olfactory cues to aid in advertising;
means to connect a portable electronic device to the panel to effectuate transfer of digital media files to portable electronic device;
means to connect a portable electronic device to the panel to effectuate making at least one of a phone call, video call, and VOIP call;
distribution means on the panel for distributing a SIM card to a user;
networking means for connecting the kiosk to other like kiosks and to a central computer network; and
credit card acceptance means on the panel for a user to provide payment information to the kiosk to pay for goods and services rendered by the kiosk.

2. The kiosk of claim 1, wherein the display device is a touch sensitive screen for purposes of providing an interactive user interface.

3. The kiosk of claim 1, wherein the digital user interface comprises:
a home page that displays media files for sale;
prices that are displayed that correspond to the cost to download a media file; and
a shopping cart link on the home page that navigates to a virtual shopping cart, the cart organizing and displaying the products to be purchased and their corresponding costs.

4. The kiosk of claim 1, wherein the digital user interface comprises a telephone and VOIP interface that provides a user with a virtual dial pad to effectuate a phone call.

5. The kiosk of claim 1, further comprising a video camera on the panel to allow a user to be video recorded for the purpose of making a video call.

6. The kiosk of claim 5, wherein the digital user interface further comprises a video display in conjunction with the portable electronic device, telephone, and VOIP interface that provides a user with a means for making a video call.

7. A kiosk comprising:
a substantially vertical structural panel for the purpose of effectuating user interaction with the kiosk;
connecting means of the panel so that the panel can physically connect to like panels for the purpose of assembling a multi-panel kiosk;
a connecting means of the panel so that the panel can electronically and electrically connect to like panels for the purpose of assembling a multi-panel kiosk;
a processing unit of the kiosk that runs software for operating the kiosk, the software having a user interface, point of sale and payment processing functionality, VOIP service functionality, and advertising functionality;
a networking means for connecting the processing unit to other like kiosks and to a central computer network;
a digital shopping cart in communication with the user interface;
a display device in association with the panel that communicates with the processing unit and is controlled by the software and displays the user interface and advertising to a user;
at least one fragrance dispenser proximate the user interface that is controlled by the software for the purpose of dispensing olfactory cues that relate to advertising;
a touch screen in association with the panel that communicates with the processing unit and is controlled by the software and accepts user input;
means to connect a portable electronic device to the panel to effectuate transfer of digital media files to portable electronic device;
a communication means with the processing unit that serves as an input and output device for telephone calls and VOIP service;
a video camera on the panel and in communication with the processing unit to allow a user to be video recorded for the purpose of making a video call.
a distribution means on the panel for distributing a SIM card to a user; and
a credit card acceptance means on the panel for a user to provide payment information to the kiosk to pay for goods and services rendered by the kiosk.

8. The kiosk of claim 7, wherein the digital user interface comprises:
a home page that displays media files for sale;
prices that are displayed that correspond to the cost to download a media file; and
a shopping cart link on the home page that navigates to a virtual shopping cart, the cart organizing and displaying the products to be purchased and their corresponding costs.

9. The kiosk of claim 7, wherein the digital user interface comprises a telephone and VOIP interface that provides a user with a virtual dial pad to effectuate a phone call.

10. The kiosk of claim 7, wherein the digital user interface further comprises a video display in conjunction with the telephone and VOIP interface that provides a user with a means for making a video call.

11. A method of assembling a kiosk assembly comprising the steps of:
providing a plurality of kiosk panels, each panel being an individual functional kiosk unit having a top, bottom, and side edges, and a substantially flat profile, the side edges comprising at least one connecting means for the purpose of attaching the side edge of an individual panel to the side edge of another individual panel;
connecting one side edge of an individual kiosk panel to the side edge of another individual kiosk panel to form a kiosk assembly; and
installing the kiosk assembly in a venue.

12. The method of claim 11, further comprising the step of connecting a single processing unit to control all the kiosk panels of a kiosk assembly.

13. The method of claim 11, further comprising the step of displaying at least one advertisement on a kiosk panel.

14. The method of claim 11, further comprising the step of dispersing a fragrance from a kiosk panel.

15. The method of claim 11, further comprising the step of providing a user interface for the purpose of interacting with a user.

16. The method of claim 11, further comprising the step of receiving input from a user.

17. The method of claim 11, further comprising the step of distributing a SIM card to a user.

18. The method of claim 11, further comprising the step of providing a credit card payment means to a user.

19. The method of claim 17, further comprising the step of receiving credit card payment information from a user.
